(19) United States
(12) Patent Application Publication
(10) Pub. No.: US 2013/0076147 A1
(43) Pub. Date: Mar. 28, 2013

(54) MULTIPLE BATTERY POWER PATH MANAGEMENT SYSTEM

(71) Applicants: Ni Sun, Sunnyvale, CA (US); Edward Zhang, Ningbo (CN)

(72) Inventors: Ni Sun, Sunnyvale, CA (US); Edward Zhang, Ningbo (CN)

(73) Assignee: FAIRCHILD SEMICONDUCTOR CORPORATION, San Jose, CA (US)

(21) Appl. No.: 13/559,236

(22) Filed: Jul. 26, 2012

Related U.S. Application Data
(60) Provisional application No. 61/540,491, filed on Sep. 28, 2011.

(51) Int. Cl. H02J 1/00

(52) U.S. Cl. 307/80

(57) ABSTRACT

Devices, systems and methods are provided for multiple battery power path management. The device may include a first battery port configured to couple to a first battery; a second battery port configured to couple to a second battery; an output voltage port configured to couple to a device to be powered; a battery selection port configured to couple to the device to be powered; a control circuit configured to select one of the first battery and the second battery as a power source battery, the selection based on a signal received at the battery selection port; and a first switch configured to selectively couple the first battery port or the second battery port to the output voltage port, the selective coupling based on a first switching signal generated by the control circuit in response to the selection of the power source battery.

### CROSS REFERENCE TO RELATED APPLICATIONS

This application claims the benefit of U.S. provisional patent application Ser. No. 61/540,491 filed Sep. 28, 2011, which is incorporated fully herein by reference.

### FIELD

The present disclosure relates to a battery power path management system, and more particularly, to a battery power path management system for multiple batteries.

### BACKGROUND

Many electronic devices, particularly portable devices such as mobile phones, digital cameras, media players, Global Positioning System (GPS) receivers and portable games are powered by batteries. Batteries eventually run low on power forcing an interruption in the use of the device. Either the battery must be replaced or recharged, which may be inconvenient and time consuming. In the case of a mobile phone, for example, a low battery may cause the call to be dropped.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a top-level block diagram consistent with various embodiments of the present disclosure;

FIG. 2 illustrates a functional block diagram consistent with various embodiments of the present disclosure;

FIG. 3 illustrates a functional block diagram consistent with various embodiments of the present disclosure;

FIG. 4 illustrates a flowchart of operations consistent with various embodiments of the present disclosure;

FIG. 5 illustrates a flowchart of operations consistent with various embodiments of the present disclosure; and

FIG. 6 illustrates a flowchart of operations consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems and methods for battery power path management for multiple batteries. The systems provide a capability to deliver power from one or more batteries to a device as well as capability to charge one or more batteries. Battery voltage monitoring circuitry may determine if a first battery voltage falls below a threshold value indicating a low battery condition. In response to such a determination, the system may switch the power path to permit power to be delivered to the device from a second battery. The system may then also initiate charging of the first battery. Battery identification (ID) detection may also be provided so that the system may determine the presence of batteries and reduce switching time which may also provide the capability for hot-swapping of batteries. Additionally, reverse current blocking (RCB) protection is provided between each of the batteries and between the device to be powered and each of the batteries. RCB prevents current from flowing from one battery to another or from the device back to any battery even if the voltage at one battery is higher than the voltage at another battery or the voltage at the output port to the device is higher than the voltage at any of the batteries.

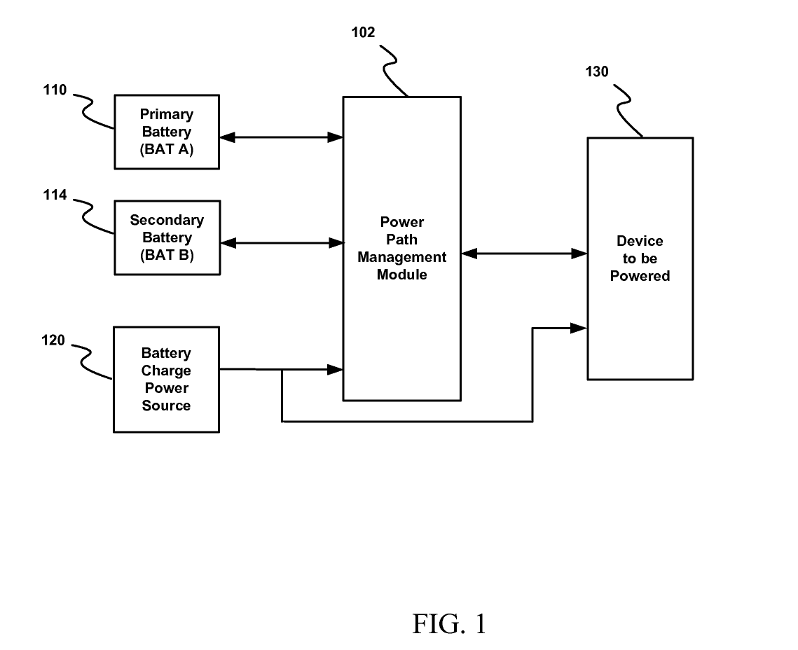

FIG. 1 illustrates a top-level block diagram 100 consistent with various embodiments of the present disclosure. Block diagram 100 illustrates power path management module 102 in an example application based on a dual battery device. Power path management module 102 provides power to a device 130 from either a primary battery 110 or a secondary battery 114 with RCB protection, as will be described in greater detail below. The device 130 may be any type of multiple battery device including, for example, a cell phone, a portable media player, a mobile internet device or any type of portable equipment. Battery charge power source 120 may be configured to provide power that power path management module 102 may direct to either battery 110 or 114 for charging/re-charging of that battery.

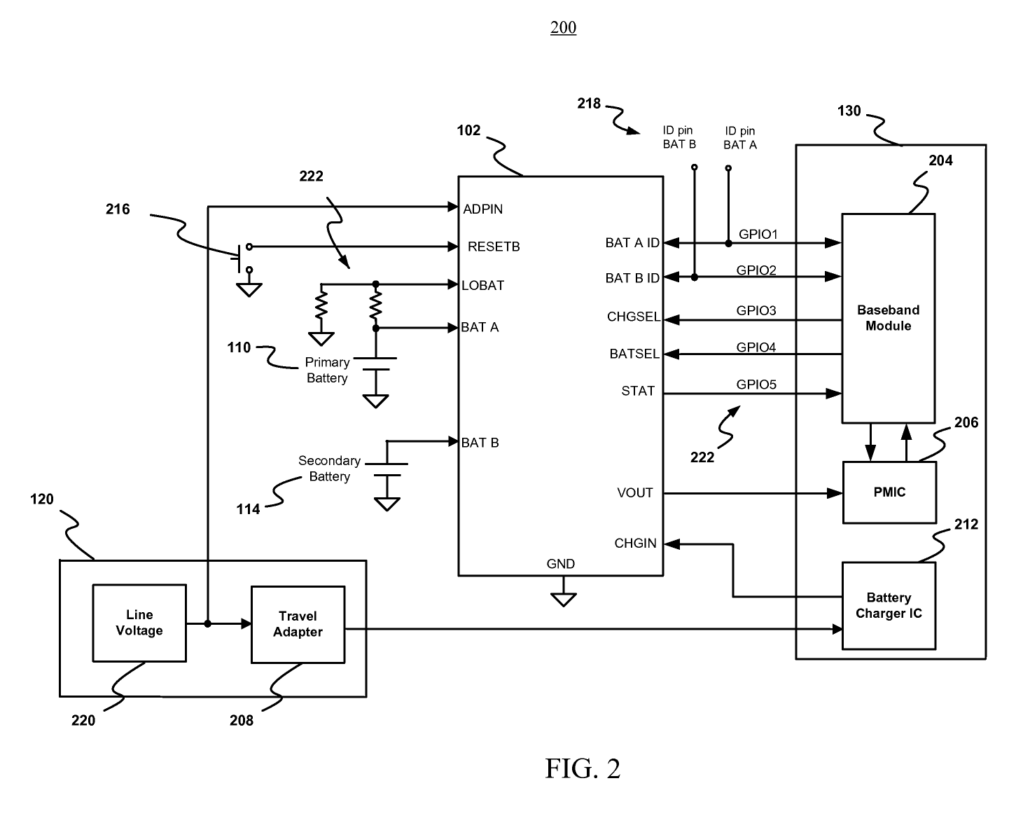

FIG. 2 illustrates a functional block diagram 200 consistent with various embodiments of the present disclosure. Block diagram 200 illustrates the power path management module 102 in an example application based on a dual battery device. Power path management system 102 provides power to a power management integrated circuit (PMIC) 206 associated with the device to be powered 130. The power may be provided from either primary battery 110 (also referred to as BAT A) or secondary battery 114 (also referred to as BAT B), either of which may be removable. ID pins 218 associated with each battery provide a status indicator of that battery's availability. In some embodiments, a battery may be indicated to be present when the ID pin signal is pulled down to ground and absent when the ID pin signal is high. The baseband module 204 may be circuitry within the device that is configured to perform control and status functions associated with power management of the device and may communicate with power path management system 102 through general purpose input/output (GPIO) lines 222.

Battery charger integrated circuit 212 may be a module within device 130 that is configured to provide power which power path management system 102 may direct to either battery 110 or 114 for charging/re-charging of that battery. Travel adapter 208 may be a module, external to device 130, which provides a charging power source to power path management system 102 through battery charger integrated circuit 212. In some embodiments the travel adapter 208 may provide a 5 volt power source which may be derived from a line voltage 220.

An external reset pin 216 may be provided to disconnect both system power path switches from system loads, which may be useful with devices having non-removable batteries. A reset delay, for example a 5 second delay, may be provided to reduce the possibility of accidental resets.

A resistor network 222 may be employed as a voltage divider to measure the voltage of one of the batteries, for example the primary battery 110, and provide an indication of a low battery voltage condition to power path management system 102.

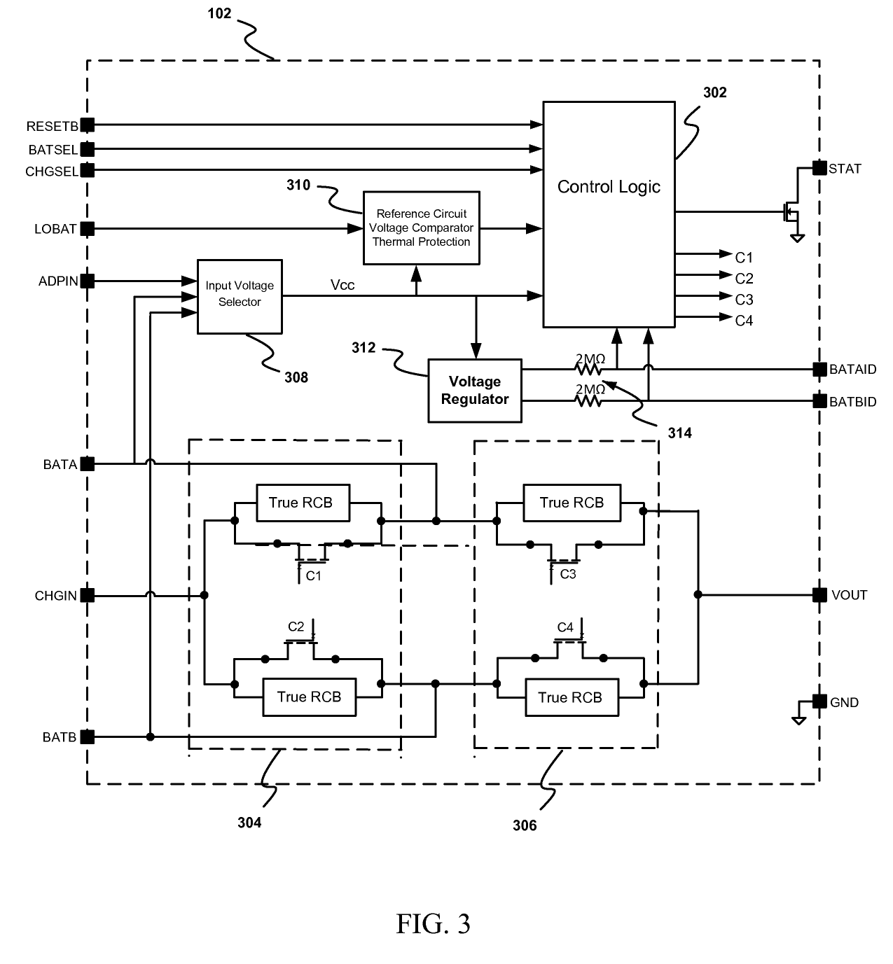

FIG. 3 illustrates a functional block diagram 300 of the power path management system 102 consistent with various embodiments of the present disclosure. Control logic block 302 receives charge select (CHGSEL) and battery select (BATSEL) signals and generates control signals C1, C2, C3, C4 to control the gate signal of charge select switches 304 and output select switches 306. Charge select switches 304 determine which battery, BAT A (corresponding to primary battery 110) or BAT B (corresponding to secondary battery 114), will be connected to CHGIN for charging. Output select switches 306 determine which battery, BAT A or BAT B, will be connected to VOUT to supply power to the device.

Reverse current blocking may be provided on one or more switches 304, 306. RCB prevents current from flowing from one battery to another or from the device back to any battery even if the voltage at one battery is higher than the voltage at another battery or the voltage at the output port to the device is higher than the voltage at any of the batteries. Such reverse current, if not blocked, could damage the batteries or the device circuitry. In some embodiments, reverse current may be blocked regardless of the state of the switch being open or closed (i.e., on or off). This type of RCB, which provides protection whether the switch is on or off, is referred to as true reverse current blocking (TRCB).

Input voltage selector 308 determines whether supply power (Vcc) for the power path management system 102 components will be provided by travel adapter 208, BAT A, or BAT B. A voltage reference circuit and voltage comparator 310 may determine whether one of the batteries is in a low voltage condition by monitoring the LOBAT voltage and providing a signal to control logic block 302 that may be used to switch the battery output and/or charging configuration in response to such condition. The low voltage condition may be determined based on an adjustable voltage threshold to the comparator. In some embodiments the threshold may be approximately 3.6 volts.

Voltage regulator 312 may provide a voltage through resistors 314 to generate an ID signal to detect the presence of Batteries. In some embodiments, the resistors may be a nominal 2 mega-ohms and the voltage may be a nominal 2.8 volts.

In some embodiments, the on-resistance between the battery and the device load may be less than approximately 80 milli-ohms and the on-resistance between the battery and the charger may be less than approximately 130 milli-ohms. Such decreased resistance values may extend battery life. Thermal shutdown and electro-static discharge protection may also be provided. The switches may be configured as P-channel MOSFET switches. The system may be configured prevent unintended shutdown of the device due to a low battery condition.

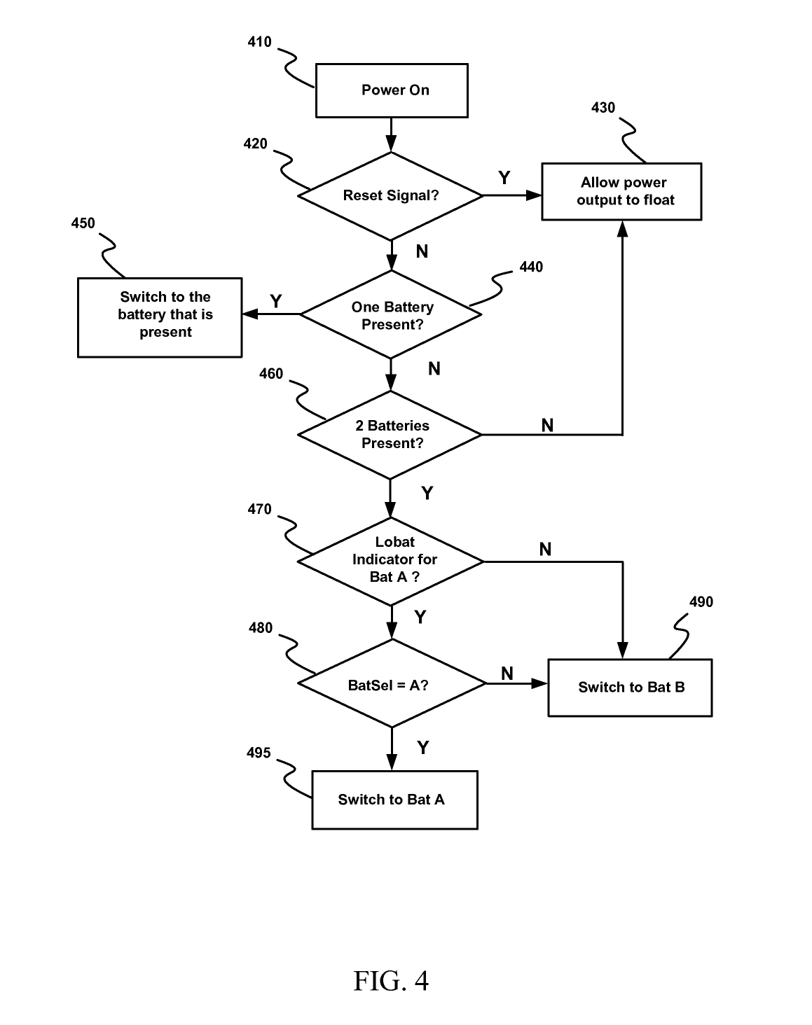

FIG. 4 illustrates a flowchart of operations 400 for output path switching consistent with various embodiments of the present disclosure. At operation 410, the system is powered on and if the reset signal is present, operation 420, the power output is allowed to float at operation 430. Otherwise, at operation 440, if battery A ID and battery B ID indicate that one, but not both, batteries are present, then the power output path is switched, at operation 450, to the one battery which is indicated to be present. Otherwise, at operation 460, if both batteries are determined to be absent then the power output is allowed to float at operation 430. Otherwise, both batteries are present. In such case, at operation 470, if the low battery indicator for battery A is present, then the power output path is switched to battery B at operation 490. Otherwise, at operation 480, one of the two batteries will be selected based on the battery selection signal, BATSEL, from the device. The power output path is switched to the selected battery at operations 490 and 495.

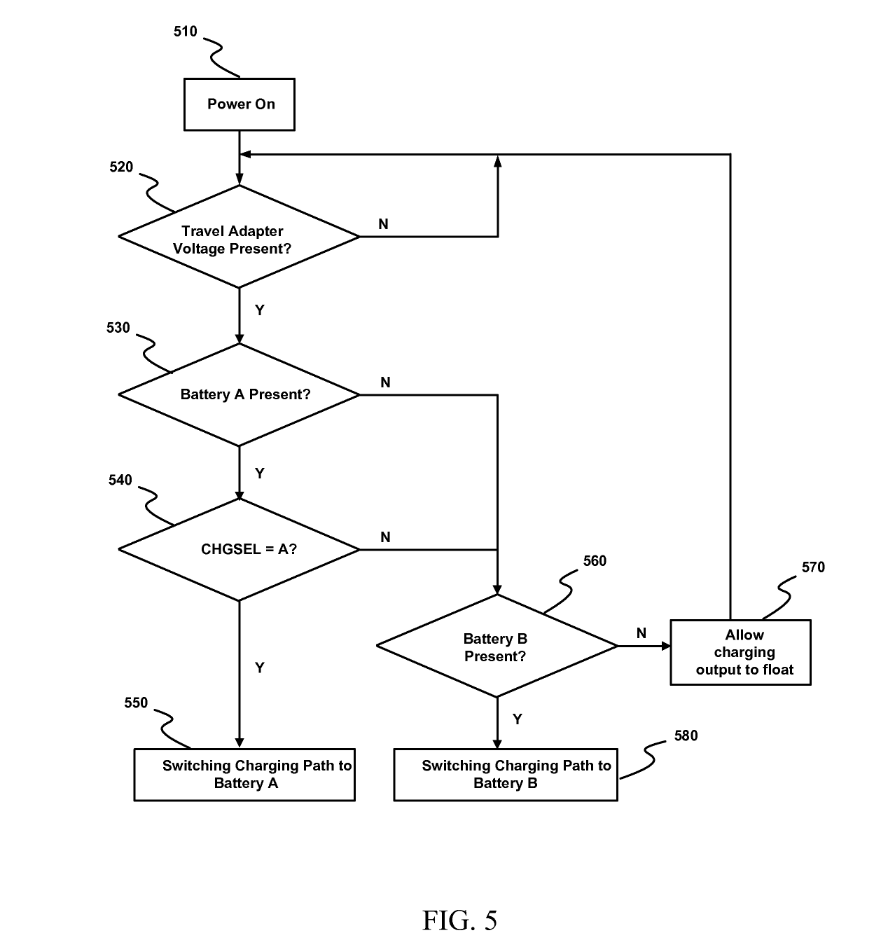

FIG. 5 illustrates a flowchart of operations 500 for charge path switching consistent with various embodiments of the present disclosure. At operation 510, the system is powered on and if the travel adapter input voltage is not present, at operation 520, the charging output is allowed to float at operation 570. In some embodiments, the travel adapter input voltage may be greater than approximately 4.6 volts to be detected as present. If battery A ID indicates that battery A is present, at operation 530, and the charge selection signal indicates that battery A should be charged, at operation 540, then the charging path is switched to charge battery A, at operation 550. Otherwise, if battery B ID indicates that battery B is present, at operation 560, and the charge selection signal indicates that battery B should be charged, at operation 540, then the charging path is switched to charge battery B, at operation 580. Otherwise, the charging output is allowed to float, at operation 570.

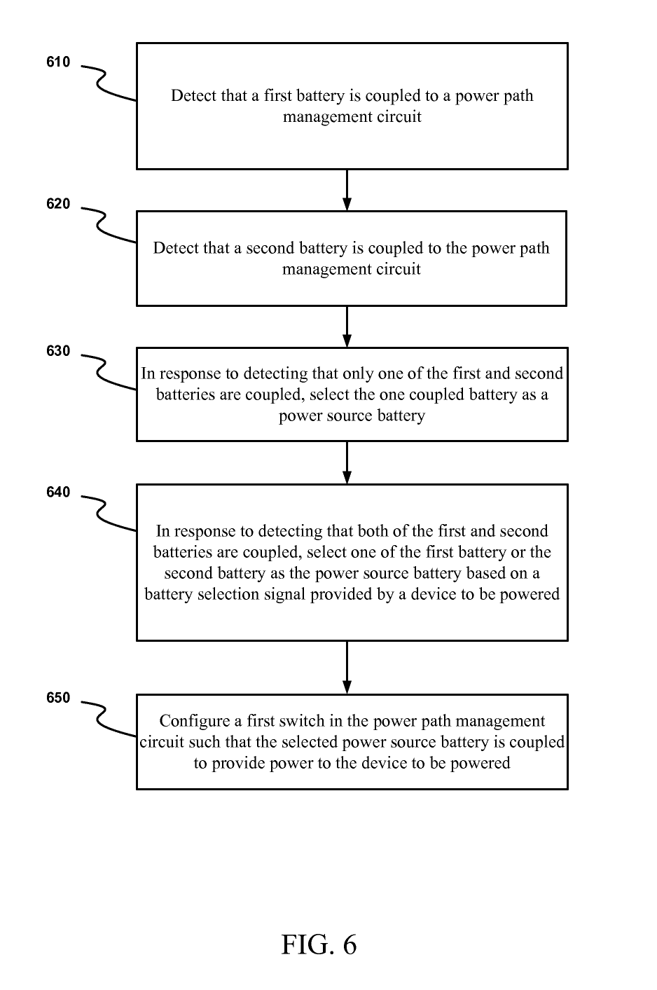

FIG. 6 illustrates a flowchart of operations 600 consistent with various embodiments of the present disclosure. At operation 610, the presence of a first battery coupled to a power path management circuit is detected. At operation 620, the presence of a second battery coupled to a power path management circuit is detected. At operation 630, in response to detecting that only one of the first and second batteries are coupled, the one coupled battery is selected as a power source battery. At operation 640, in response to detecting that both of the first and second batteries are coupled, one of the first battery or the second battery is selected as the power source battery based on a battery selection signal provided by a device to be powered. At operation 650, a first switch in the power path management circuit is configured such that the selected power source battery is coupled to provide power to the device to be powered.

Although much of the disclosure has been directed towards power path management of a system comprising two batteries, for simplicity of explanation, it will be appreciated that other embodiments may extend the power path management capabilities to any number of batteries.

As used herein, use of the term “nominal” or “nominally” when referring to an amount means a designated or theoretical amount that may vary from the actual amount.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

The term “switches” may be embodied as MOSFET switches (e.g. individual NMOS and PMOS elements), BJT switches and/or other switching circuits known in the art. In addition, “circuitry” or “circuit”, as used in any embodiment herein, may comprise, for example, singly or in any combination, hardwired circuitry, programmable circuitry, state machine circuitry, and/or circuitry that is included in a larger system, for example, elements that may be included in an integrated circuit.

Thus, the present disclosure provides devices, systems and methods for multiple battery power path management. According to one aspect there is provided a device. The device may include a first battery port configured to couple to a first battery. The device of this example may also include a second battery port configured to couple to a second battery. The device of this example may further include an output voltage port configured to couple to a device to be powered. The device of this example may further include a battery selection port configured to couple to the device to be powered. The device of this example may further include a control circuit configured to select one of the first battery and the second battery as a power source battery, the selection based on a signal received at the battery selection port. The device of this example may further include a first switch configured to selectively couple the first battery port or the second battery port to the output voltage port, the selective coupling based on a first switching signal generated by the control circuit in response to the selection of the power source battery.

According to another aspect there is provided a method. The method may include detecting that a first battery is coupled to a power path management circuit. The method of this example may also include detecting that a second battery is coupled to the power path management circuit. The method of this example may further include, in response to detecting that only one of the first battery and the second battery is coupled, selecting the one coupled battery as a power source battery. The method of this example may further include, in response to detecting that both of the first battery and the second battery are coupled, selecting one of the first battery and the second battery as the power source battery, the selection based on a battery selection signal provided by a device to be powered. The method of this example may further include configuring a first switch in the power path management circuit such that the selected power source battery is coupled to provide power to the device to be powered.

According to another aspect there is provided a system. The system may include a power path management device including a first battery port configured to couple to a first battery. The power path management device of this example may also include a second battery port configured to couple to a second battery. The power path management device of this example may further include an output voltage port configured to couple to a device to be powered. The power path management device of this example may further include a battery selection port configured to couple to the device to be powered. The power path management device of this example may further include a control circuit configured to select one of the first battery and the second battery as a power source battery, the selection based on a signal received at the battery selection port. The power path management device of this example may further include a first switch configured to selectively couple the first battery port or the second battery port to the output voltage port, the selective coupling based on a first switching signal generated by the control circuit in response to the selection of the power source battery. The system of this example may further include a voltage divider coupled to the first battery and coupled to a low battery indicator port on the power path management device, the voltage divider configured to provide an indication of a low battery condition associated with the first battery.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A power path management device, comprising:
a first battery port configured to couple to a first battery;
a second battery port configured to couple to a second battery;
an output voltage port configured to couple to a device to be powered;
a battery selection port configured to couple to said device to be powered;
a control circuit configured to select one of said first battery and said second battery as a power source battery, said selection based on a signal received at said battery selection port; and
a first switch configured to selectively couple said first battery port or said second battery port to said output voltage port, said selective coupling based on a first switching signal generated by said control circuit in response to said selection of said power source battery.

2. The device of claim 1, wherein said first switch is configured to provide true reverse current blocking.

3. The device of claim 1, wherein said control circuit is further configured to determine that said first battery is coupled to said first battery port and that said second battery is coupled to said second battery port.

4. The device of claim 3, wherein said control circuit selection of said power source battery is further based on said determination of said battery couplings.

5. The device of claim 1, further comprising a voltage comparator circuit configured to detect a low battery condition associated with said first battery, wherein said control circuit selection of said power source battery is further based on said detection.

6. The device of claim 1, further comprising:
a charging voltage port configured to couple to a charging voltage source;
a charge selection port configured to couple to said device to be powered; and
a second switch configured to selectively couple said first battery port or said second battery port to said charging voltage port, said selective coupling based on a second switching signal generated by said control circuit in response to a signal received at said charge selection port.

7. The device of claim 6, wherein said second switch is configured to provide true reverse current blocking.

8. The device of claim 6, wherein said control circuit generation of said second switching signal is further based on said determination of said battery couplings.

9. A method, comprising:
detecting that a first battery is coupled to a power path management circuit;
detecting that a second battery is coupled to said power path management circuit;
in response to detecting that only one of said first battery and said second battery is coupled, selecting said one coupled battery as a power source battery;
in response to detecting that both of said first battery and said second battery are coupled, selecting one of said first battery and said second battery as said power source battery, said selection based on a battery selection signal provided by a device to be powered; and
configuring a first switch in said power path management circuit such that said selected power source battery is coupled to provide power to said device to be powered.

10. The method of claim 9, further comprising detecting a low battery condition associated with said first battery and, in response to said detected condition, selecting said second battery as said power source battery.

11. The method of claim 9, wherein said first switch provides true reverse current blocking.

12. The method of claim 9, further comprising:
detecting that a charging voltage source is coupled to said power path management circuit;
selecting one of said first battery and said second battery as a charge battery, said selection based on a charge selection signal provided by said device to be powered; and
configuring a second switch in said power path management circuit such that said selected charge battery is coupled to said charging voltage source.

13. The method of claim 12, further comprising, in response to detecting that said first battery is not coupled, selecting said second battery as said charge battery.

14. The method of claim 12, wherein said second switch provides true reverse current blocking.

15. A system, comprising:
a power path management device comprising:
a first battery port configured to couple to a first battery;
a second battery port configured to couple to a second battery;
an output voltage port configured to couple to a device to be powered;
a battery selection port configured to couple to said device to be powered;
a control circuit configured to select one of said first battery and said second battery as a power source battery, said selection based on a signal received at said battery selection port; and
a first switch configured to selectively couple said first battery port or said second battery port to said output voltage port, said selective coupling based on a first switching signal generated by said control circuit in response to said selection of said power source battery; and
a voltage divider coupled to said first battery and coupled to a low battery indicator port on said power path management device, said voltage divider configured to provide an indication of a low battery condition associated with said first battery.

16. The system of claim 15, wherein said first switch is configured to provide true reverse current blocking.

17. The system of claim 15, wherein said control circuit is further configured to determine that said first battery is coupled to said first battery port and that said second battery is coupled to said second battery port.

18. The system of claim 17, wherein said control circuit selection of said power source battery is further based on said determination of said battery couplings.

19. The system of claim 15, further comprising a voltage comparator circuit configured to compare a voltage at said low battery indicator port to a threshold voltage to detect a low battery condition associated with said first battery, wherein said control circuit selection of said power source battery is further based on said detection.

20. The system of claim 15, further comprising:
a charging voltage port configured to couple to a charging voltage source;
a charge selection port configured to couple to said device to be powered; and
a second switch configured to selectively couple said first battery port or said second battery port to said charging voltage port, said selective coupling based on a second switching signal generated by said control circuit in response to a signal received at said charge selection port.

21. The device of claim 20, wherein said second switch is configured to provide true reverse current blocking.

22. The device of claim 20, wherein said control circuit generation of said second switching signal is further based on said determination of said battery couplings.
